(19) United States
(12) Patent Application Publication
(10) Pub. No.: US 2014/0368694 A1
(43) Pub. Date: Dec. 18, 2014

(54) ELECTRONIC DEVICE FOR PROCESSING VIDEO DATA AND METHOD THEREOF

(71) Applicant: Samsung Electronics Co., Ltd., Gyeonggi-do (KR)

(72) Inventors: Seung-Yeon Eom, Seoul (KR); Byung-Soo Kim, Gyeonggi-do (KR)

(73) Assignee: Samsung Electronics Co., Ltd.

(21) Appl. No.: 14/301,012

(22) Filed: Jun. 10, 2014

(30) Foreign Application Priority Data
Jun. 14, 2013 (KR) 10-2013-0068606

(51) Int. Cl. H04N 1/21

(52) U.S. Cl. CPC H04N 1/2158
USPC 348/231.9

(57) ABSTRACT

A method for processing video data in an electronic device is provided. The method includes connecting communication with an external storage, obtaining video data through an image sensor, and transmitting the video data to the external storage if an amount of the video data reaches a transmission capacity.

### PRIORITY

This application claims priority under 35 U.S.C. §119(a) to a Korean Patent Application filed in the Korean Intellectual Property Office on Jun. 14, 2013 and assigned Serial No. 10-2013-0068606, the contents of which are incorporated herein by reference.

### BACKGROUND OF THE INVENTION

1. Field of the Invention

The present invention relates generally to a user device and an operating method thereof.

2. Description of the Related Art At present, due to the growth of electronic communication industries, user devices such as cellular phones, electronic schedulers, personal complex terminals, laptop computers and the like are becoming necessities to modern society and are becoming a significant means for delivery of fast changing information. The user devices make users' work convenient through a Graphical User Interface (GUI) environment using a touch screen, and have provided various multimedia based on a web environment.

Most user devices have photography functions as basic specifications and it is hard to find user devices having no shooting functions. Due to the characteristics of the user devices to be easy carried, users can immediately capture an important moment.

### SUMMARY OF THE INVENTION

The present invention has been made to address at least the above problems and/or disadvantages and to provide at least the advantages below.

Accordingly, an aspect of the present invention is to provide a user device which can take a large video regardless of an available capacity of a memory and an operating method thereof.

Another aspect of the present invention is to provide a user device which can secure an available capacity of a memory while continuously taking a large video by transmitting video data obtained from an image sensor to an external storage (e.g., a server, an external memory, or the like) when the amount of the video data reaches a video data transmission capacity.

Another aspect of the present invention is to provide a user device which can adjust the amount of video data which are obtained from an image sensor and are transmitted to an external storage.

Another aspect of the present invention is to provide a user device which can adjust a transmission capacity of video data, which are obtained from an image sensor and are transmitted to an external storage, to an available capacity of a memory (e.g., a buffer memory) or less.

Another aspect of the present invention is to provide a user device which can set, by a user, a transmission capacity of video data which are obtained from an image sensor and are transmitted to an external storage.

Another aspect of the present invention is to provide a user device which can adjust a transmission capacity of video data, which are obtained from an image sensor and are transmitted to an external storage, adaptively responsive to a network type and/or network state with the external storage.

Another aspect of the present invention is to provide a user device which can create a plurality of video files sequentially obtained from a user device as one video file, and store the created video file.

Another aspect of the present invention is to provide a user device which can provide a stored video file to a user device in response to a provision request of the user device.

In accordance with an aspect of the present invention, a method in an electronic device is provided. The method includes connecting communication with an external storage, obtaining video data through an image sensor, and transmitting the video data to the external storage if an amount of the video data reaches a transmission capacity.

In accordance with another aspect of the present invention, an electronic device is provided. The electronic device includes a communication module for connecting communication with an external storage, an acquisition module for obtaining video data through an image sensor, and a transmission module for, if an amount of the video data reaches a transmission capacity, transmitting the video data to the external storage.

In accordance with another aspect of the present invention, a method in an external storage is provided. The method includes connecting communication with a user device, sequentially obtaining a plurality of video files from the user device, creating the plurality of video files as one file, and storing the created file.

In accordance with another aspect of the present invention, an external storage is provided. The external storage includes a communication module for connecting communication with a user device, an acquisition module for sequentially obtaining at least one video file from the user device, and a creation module for creating the at least one video files as one file, and storing the created file.

In accordance with another aspect of the present invention, an electronic device is provided. The electronic device includes an image sensor for obtaining video data, at least one or more processors for executing computer programs, a memory for storing data and instructions, and at least one or more programs stored in the memory and configured to be executable by the at least one or more processors. The at least one or more programs connect communication with an external storage, obtains video data through the image sensor, and transmits the video data to the external storage if an amount of the video data reaches a transmission capacity. The transmission capacity is adjusted to an available capacity of the memory or less.

In accordance with another aspect of the present invention, an external storage is provided. The external storage includes an image sensor for obtaining video data, at least one or more processors for executing computer programs, a memory for storing data and instructions, and at least one or more programs stored in the memory and configured to be executable by the at least one or more processors. The at least one or more programs connect communication with a user device, sequentially obtains a plurality of video files from the user device, creates the plurality of video files as one file, and stores the created file.

### BRIEF DESCRIPTION OF THE DRAWINGS

The above and other aspects, features, and advantages of certain embodiments of the present invention will become more apparent from the following detailed description when taken in conjunction with the accompanying drawings in which:

FIG. 1 is a block diagram illustrating a construction of a user device according to an embodiment of the present invention;

FIG. 2 illustrates a construction of a shooting module according to an embodiment of the present invention;

FIG. 3 is a flowchart illustrating a procedure of processing video data in a user device according to an embodiment of the present invention;

FIG. 4 is a flowchart illustrating a procedure of adjusting a transmission capacity of video data according to an embodiment of the present invention;

FIG. 5 is a flowchart illustrating a procedure of step 403 of FIG. 4 according to an embodiment of the present invention;

FIG. 6 is a flowchart illustrating a procedure of step 307 of FIG. 3 according to an embodiment of the present invention;

FIG. 7 illustrates a construction of an external storage according to an embodiment of the present invention; and

FIG. 8 is a flowchart illustrating a procedure of processing a video file in an external storage according to an embodiment of the present invention.

### DETAILED DESCRIPTION OF EMBODIMENTS OF THE PRESENT INVENTION

Various embodiments of the present invention will be described herein below with reference to the accompanying drawings. In the following description, well-known functions or constructions are omitted for clarity and conciseness. The terms described below, which are defined considering functions in the present invention, can be different depending on a user's and an operator's intention or practice. Therefore, the terms should be defined on the basis of the disclosure throughout this specification.

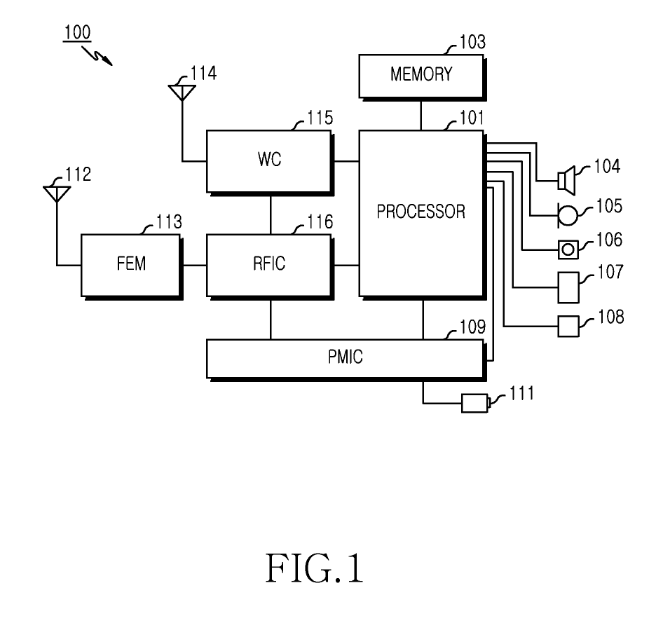

FIG. 1 is a block diagram illustrating a construction of a user device according to an embodiment of the present invention.

The user device 100 can be an electronic device such as a mobile phone, a mobile pad, a media player, a tablet computer, a handheld computer, a Personal Digital Assistant (PDA), and a digital camera. The digital camera can be a compact digital camera, a high-end digital camera, a hybrid digital camera, a Digital Single Lens Reflex (DSLR) camera or a Digital Single Lens Translucent (DSLT) camera. Also, the user device 100 may be any user device including a device combining two or more functions among these devices.

Referring to FIG. 1, the user device 100 includes a processor 101, a memory 103, a speaker 104, a microphone 105, a camera 106, a display 107, a touch panel 108, a Power Manager Integrated Circuit (PMIC) 109, a battery 111, a cellular antenna 112, a Front End Module (FEM) 113, a Wireless Connectivity (WC) antenna 114, WC 115, and a Radio Frequency Integrated Circuit (RFIC) 116.

The processor 101 controls the general operation of the user device 100. The processor 101 performs a function of executing an Operating System (OS) and application program of the user device 100 and a function of controlling other parts and devices. The processor 101 can include an Application Processor (AP) for performing a key function of the entire system, a Communication Processor (CP) for performing communication, a Graphic Processing Unit (GPU) for processing 2-Dimensional (2D) and 3-Dimensional (3D) graphics, an Image Signal Processor (ISP) for taking charge of image signal processing, an Audio Signal Processor (ASP) for taking charge of voice signal processing, a memory semiconductor, a system interface, and the like. The processor 101 can be a System On Chip (SOC) in which various parts are integrated as one.

The AP plays the role of the brain of the user device 100, and can support a function of computation processing, a function of playing contents of various formats such as an audio, an image, a video and the like, a graphic engine, and the like. The AP can drive an operating system applied to the user device 100, various functions, and the like. The AP can perform a great number of functions of a core, a memory, a display system/controller, a multimedia encoding/decoding codec, a 2D/3D accelerator engine, an ISP, a camera, an audio, a modem, various high and low speed serial/parallel connectivity interfaces, and the like. The AP can execute various software programs (i.e., instruction sets) stored in the memory 103 to perform various functions of the user device 100, and perform processing and control for voice communication, image communication, and data communication. The AP can execute software programs (i.e., instruction sets) stored in the memory 103 to perform various functions corresponding to the programs.

The AP can be an SOC integrating all of a GPU, an ISP, an ASP, a memory semiconductor, and a system interface.

The CP performs voice communication and/or data communication, and can compress voice data and image data or decompress the compression thereof. The CP can be a baseband modem, a Baseband Processor (BP), or the like. The CP can be designed to operate through one of a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, and a Bluetooth network.

The GPU processes computation related to graphics, and take charge of image information processing, acceleration, signal conversion, picture output, and the like. The GPU can solve a bottleneck phenomenon caused by a graphic work of the AP, and can process 2D or 3D graphics faster than the AP.

The ISP converts electrical signals (i.e., image data) from the camera 106, into image signals. The ISP can change a color sense of the image data from the camera 106 into a format such as a real image, and can adjust brightness. The ISP can perform Automatic Exposure (AE), Automatic White-Balance (AWB) automatically adjusting a white balance according to a change of a color temperature of an incident light source, Automatic Focus (AF) automatically focusing a subject, and the like. The ISP can analyze a frequency component of the image data obtained from the camera 106, and recognize a definition of an image to adjust an F-number of the iris of the camera 106 and a shutter speed. The ISP can temporarily store the image data from the camera 106, in the memory 103 (e.g., buffer memory). If the amount of video data from the camera 106 reaches a video data transmission capacity (for example, an available capacity of the memory 103 or less or a capacity of the buffer memory), the ISP can compress and encode temporarily stored video data, and create the video data as a video file.

The ASP processes computation related to an audio, and can change an audio signal of a digital or analog form through an audio effect or effect unit.

The memory 103 stores software related programs (i.e., instruction sets) executable by the aforementioned processors. The memory 103 can include high-speed random access memories and/or non-volatile memories such as one or more magnetic disk storage devices, one or more optical storage devices and/or flash memories (for example, Not AND (NAND) memories, Not OR (NOR) memories). A total of storage time of video data obtained from an image sensor can be proportional to an available capacity of the memory 103.

The memory 103 can include the buffer memory. The buffer memory can be a storage memory for temporarily storing video data obtained from an image sensor before the processor 101 (e.g., the AP or ISP) records the video data in the memory 103. The buffer memory can enable taken image data to be recorded in the memory 103 quickly and smoothly without delay. If a video is taken using the buffer memory, a time for continuously taking a video can be restrictive to a capacity of the buffer memory.

Software can include an OS program, a communication program, a camera program, a graphical program, one or more application programs, a user interface program, a codec program, and the like. The term of program may be expressed as a set of instructions or an instruction set. The OS program can use various functions of the communication program, the camera program, the graphical program, the one or more application programs, the user interface program, and the codec program through various Application Programming Interfaces (APIs).

The OS program indicates an embedded operating system such as WINDOWS, LINUX, Darwin, RTXC, UNIX, OS X, or VxWorks, and can include various software constituent elements controlling general system operation. Control of the general system operation can include memory control and management, storage hardware (device) control and management, power control and management, and the like. Also, the OS program can perform even a function of making smooth communication between various hardware (devices) and software constituent elements (programs). The communication program can enable communication with a computer, a server, a user device and the like through the WC 115, the RFIC 116, or an external port.

The camera program includes a camera related software constituent element enabling camera related processes and functions. Under support of an API such as Open Graphics Library (OpenGL), DirectX and the like, the camera program can perform preprocessing by applying various effects to an image from the image sensor of the camera 106 and postprocessing by applying various effects to a captured snap image. If video data from the camera 106 reaches a video data transmission capacity (e.g., an available capacity of the memory 103 or a capacity of the buffer memory), the camera program converts the video data into a video file, and transmit the converted video file to an external storage (e.g., a server, an external memory, or the like).

The graphical program includes various software constituent elements for providing and displaying graphics on the display 107. The graphical program can create graphics based on an API such as OpenGL, DirectX, and the like, and can provide various filters capable of applying various effects to an image. The term of graphics indicates a text, a web page, an icon, a digital image, a video, an animation, and the like. The graphical program can be an image viewer, an image edit program and the like which adapt usability to postprocess an image, and can be a camera related program, a video call related program and the like which are optimized to preprocess an image. The graphical program can perform postprocessing by applying various effects to a rendering-completed image, or perform preprocessing by applying various effects for an image. Filters for these effects can be collectively managed such that they can be used commonly to other programs as aforementioned.

The application program includes a browser, an electronic mail (e-mail), an instant message, word processing, keyboard emulation, an address book, a touch list, a widget, a Digital Right Management (DRM), voice recognition, voice replication, a position determining function, a location based service, and the like. The user interface program can include various software constituent elements related to a user interface. The user interface program can include information about how a state of the user interface is changed, whether the change of the state of the user interface is carried out in certain condition, and the like.

The CODEC program includes a software constituent element related to encoding and decoding of a video file.

Besides the aforementioned programs, the memory 103 can further include additional programs (instructions). Also, various functions of the user device 100 can be executed by hardware and/or software and/or a combination of them, which include one or more stream processing or Application Specific Integrated Circuits (ASICs).

The speaker 104 converts electrical signals into audible frequency band signals and output the audible frequency band signals. The microphone 105 can convert sound waves received from human or other sound sources into electrical signals.

The camera 106 converts light reflected from a shooting target into electrical signals. The camera 106 can include an image sensor such as a Charged Coupled Device (CCD), a Complementary Metal-Oxide-Semiconductor (CMOS), or the like. The image sensor can perform a camera function of photo and video clip recording and the like. According to a camera program executed by the AP of the processor 101, the image sensor can change a hardware construction, for example, move a lens and adjust an F-number of the iris and the like.

The display 107 outputs electrical signals as visual information (e.g., a text, a graphic, a video, and the like). The display 107 can be one of an Electro Wetting Display (EWD), an Electronic paper (E-paper), a Plasma Display Panel (PDP), a Liquid Crystal Display (LCD), an Organic Light Emitting Diode (OLED), and an Active Matrix Organic Light Emitting Diode (AMOLED).

The touch panel 108 receives a touch. The touch panel 108 can be one of a digitizer stylus pen, a capacitive overlay touch panel, a resistance overlay touch panel, a surface acoustic wave touch panel, and an infrared beam touch panel.

The PMIC 109 adjusts power from the battery 111. For example, the processor 101 can transmit an interface signal dependent on a load to be processed, to the PMIC 109. Adaptively to the processor 101, the PMIC 109 can adjust a core voltage supplied to the processor 101, so the processor 101 can be driven all the time at a minimum power. The PMIC 109 can be constructed in relation to at least one of the WC 115, the memory 103, the speaker 104, the microphone 105, the camera 106, the display 107, the touch panel 108, etc. as well as the processor 101. One integrated PMIC is constructed, and the integrated PMIC may adjust a battery power related to at least one of the aforementioned constituent elements as well as the processor 101.

The FEM 113 is a transmitting/receiving device capable of controlling an electric wave signal. The FEM 113 can connect the cellular antenna 112 and the RFIC 116 and divide transmission/reception signals. The FEM 113 can play a role of filtering and amplification. The FEM 113 can include a reception end FEM which embeds a filter filtering a reception signal and a transmission end FEM which embeds a Power Amplifier Module (PAM) amplifying a transmission signal.

The WC 115 performs various communication functions that the processor 101 does not process, for example, WiFi, Bluetooth, Near Field Communication (NFC), Universal Serial Bus (USB), Global Positioning System (GPS) and the like.

The RFIC (e.g., RF transceiver) 116 receives an electric wave from a base station, and modulate a received high frequency into a low frequency (e.g., baseband frequency) such that the modem (e.g., the CP) can process the low frequency. The RFIC 116 modulates a low frequency processed in the modem into a high frequency for transmission to the base station.

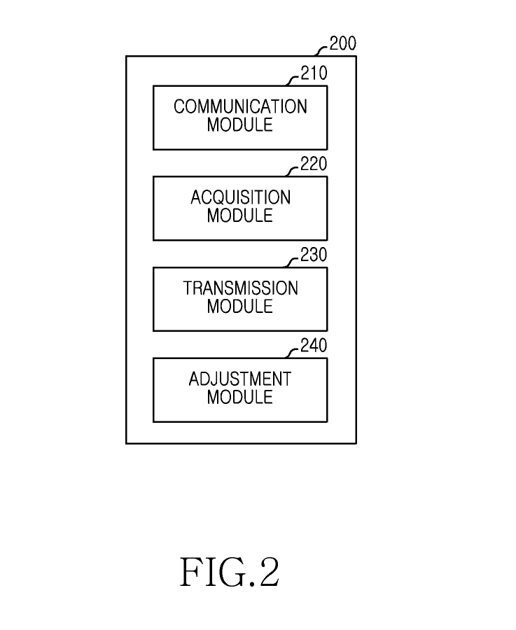

FIG. 2 illustrates a construction of a shooting module according to an embodiment of the present invention. The user device 100 may include the shooting module 200.

Referring to FIG. 2, the shooting module 200 includes a communication module 210, an acquisition module 220, a transmission module 230, and an adjustment module 240.

The communication module 210 (e.g., the CP) connects communication with an external storage. The communication module 210 can be designed to operate through at least one of a GSM network, an EDGE network, a CDMA network, a W-CDMA network, an LTE network, an OFDMA network, a Wi-Fi network, a WiMAX network, and a Bluetooth network.

The acquisition module 220 (e.g., the AP or ISP) obtains video data through an image sensor.

If the amount of video data reaches a video data transmission capacity, the transmission module 230 (e.g., the AP or ISP) transmits the video data to the external storage. The transmission module 230 converts the video data into a video file, and transmits the converted video file to the external storage. The transmission of the video file to the external storage indicates that the video file is moved to the external storage without remaining in the memory 103. Therefore, an available capacity of the memory 103 can be secured. The transmission module 230 can sequentially transmit a plurality of video files to the external storage. The transmission module 230 can add supplementary information (e.g., attribute information) indicating that the plurality of video files will have to be integrated as one, to the plurality of video files.

The adjustment module 240 (e.g., the AP or ISP) adjusts a video data transmission capacity. The adjustment module 240 confirms an available capacity of the memory 103 (e.g., the buffer memory), and adjusts the video data transmission capacity to the available capacity of the memory 103 or less. For example, the adjustment module 240 can confirm a capacity of the buffer memory, and confirm the time allowed for continuously taking a video. The adjustment module 240 (e.g., the AP or ISP) can confirm a network type and/or network state with the external storage, and adjust the video data transmission capacity in response to the network type and/or network state.

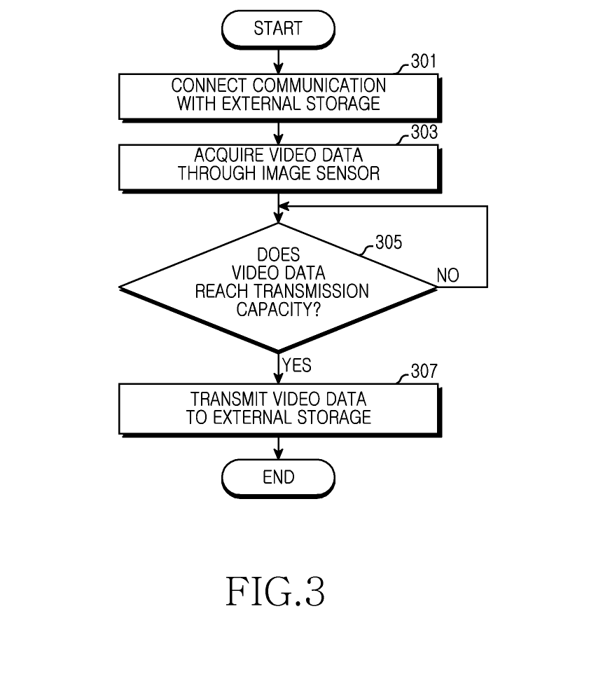

FIG. 3 is a flowchart illustrating a procedure of processing video data in a user device according to an embodiment of the present invention.

Referring to FIG. 3, in step 301, the processor 101 (e.g., the communication module 210) performs communication connection with an external storage.

In step 303, the processor 101 (e.g., the acquisition module 220) obtains video data through an image sensor.

In step 305, the processor 101 (e.g., the transmission module 230) determines if the amount of the video data reaches a video data transmission capacity.

If the amount of the video data reaches the video data transmission capacity, in step 307, the processor 101 (e.g., the transmission module) transmits the video data to the external storage.

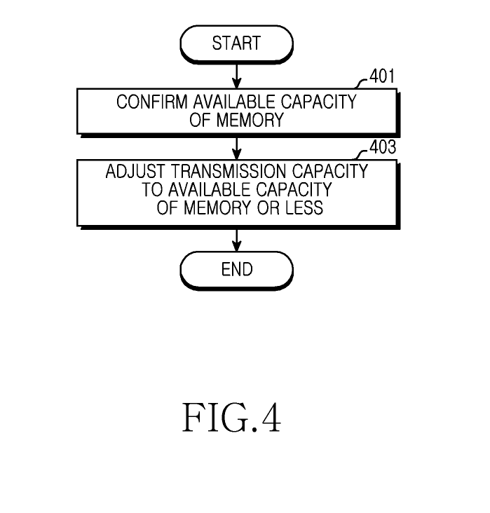

FIG. 4 is a flowchart illustrating a procedure of adjusting a transmission capacity of video data according to an embodiment of the present invention.

Referring to FIG. 4, in step 401, the processor 101 (e.g., the adjustment module 240) confirms an available capacity of the memory 103 (e.g., the buffer memory).

In step 403, the processor 101 (e.g., the adjustment module 240) adjusts the video data transmission capacity to the available capacity of the memory 103 or less. The processor 101 determines a value preset by a user, as the video data transmission capacity. The processor 101 adjusts the video data transmission capacity variably and adaptively 25 responsive to a communication state with the external storage.

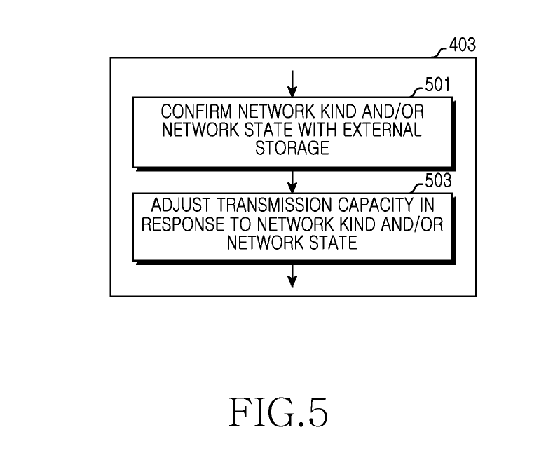

FIG. 5 is a flowchart illustrating a procedure of step 403 of FIG. 4 according to an embodiment of the present invention.

Referring to FIG. 5, in step 501, the processor 101 (e.g., the adjustment module 240) confirms a network type and/or network state with an external storage.

In step 503, the processor 101 (e.g., the adjustment module 240) adjusts a video data transmission capacity in response to the network type and/or network state. For example, the processor 101 can increase the video data transmission capacity if it is a network (e.g., an LTE network) optimal for data transmission. The processor 101 can decrease the video data transmission capacity if a network transmission speed decreases, and increase the video data transmission capacity if the network transmission speed increases.

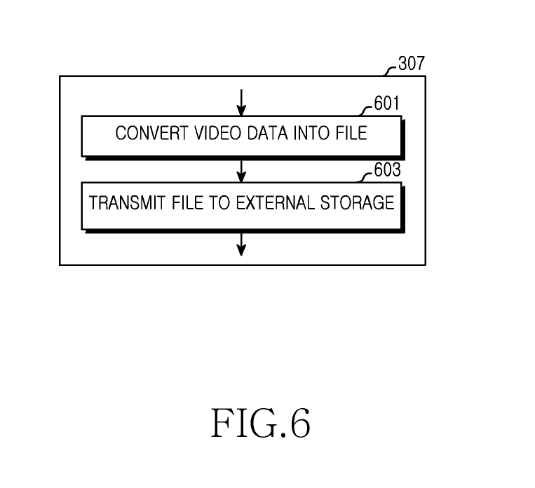

FIG. 6 is a flowchart illustrating a procedure of step 307 of FIG. 3 according to an embodiment of the present invention.

Referring to FIG. 6, in step 601, the processor 101 (e.g., the transmission module 240) converts video data into a file.

In step 603, the processor 101 (e.g., the transmission module 240) transmits the file to an external storage. A plurality of files sequentially transmitted to the external storage can have supplementary information (e.g., attribute information) indicating that the files will have to be integrated as one.

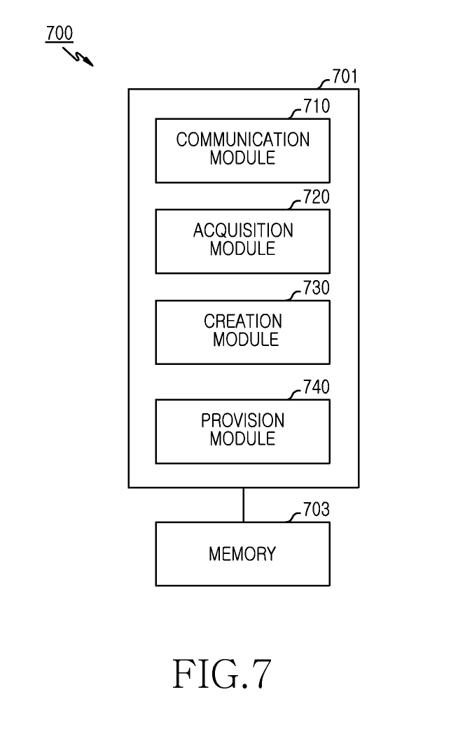

FIG. 7 illustrates a construction of an external storage according to an embodiment of the present invention.

Referring to FIG. 7, the external storage 700 includes a processor 701 and a memory 703. The processor 701 controls the general operation of the external storage 700. The processor 701 executes a software program (e.g., an instruction set) stored in the memory 703 and performs various functions corresponding to the executed software program. The processor 701 can include a communication module 710, an acquisition module 720, a creation module 730, and a provision module 740.

The communication module 710 connects communication with the user device 100. The communication module 710 can be designed to operate through at least one of a GSM network, an EDGE network, a CDMA network, a W-CDMA network, an LTE network, an OFDMA network, a Wi-Fi network, a WiMAX network, and a Bluetooth network.

The acquisition module 720 sequentially acquires a plurality of video files from the user device 100.

The creation module 730 creates the plurality of video files from the user device 100, as one video file, and store the created video file in the memory 703. From supplementary information included with the plurality of video files, the creation module 730 determines that the plurality of video files should be integrated as one. The creation module 730 sets a flag for granting the user device 100 to have access to the stored video file, to the file. The flag, which is a hidden information code for forwarding copyright related situation of a file, can prevent file illegal copying and/or file exchanging. The user device 100 can confirm the usability or non-usability of a corresponding file through the flag.

The provision module 740 provides a stored video file to the user device 100 in response to a request of the user device 100. The memory 703 stores software programs (i.e., instruction sets) executed by the processor 701.

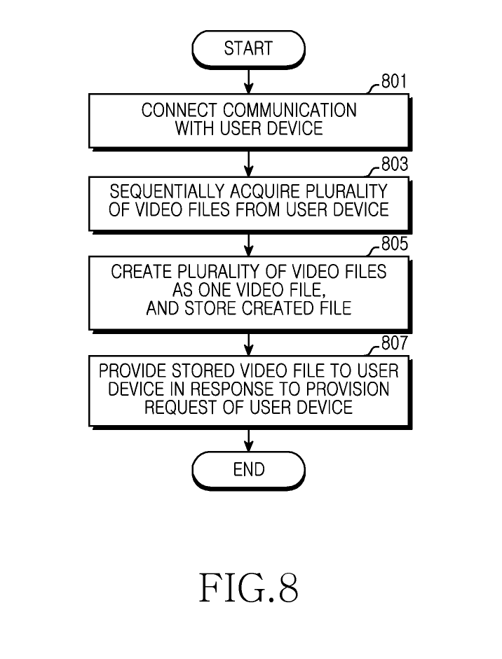

FIG. 8 is a flowchart illustrating a procedure of processing a video file in an external storage according to an embodiment of the present invention.

Referring to FIG. 8, in step 801, the processor 701 (e.g., the communication module 710) connects communication with the user device 100. The processor 701 can connect communication with the user device 100 through at least one of a GSM network, an EDGE network, a CDMA network, a W-CDMA network, an LTE network, an OFDMA network, a Wi-Fi network, a WiMAX network, and a Bluetooth network.

In step 803, the processor 701 (e.g., the acquisition module 720) sequentially acquires a plurality of video files from the user device 100.

In step 805, the processor 701 (e.g., the creation module 730) creates the plurality of video files as one video file, and stores the created video file in the memory 703. From supplementary information included with the plurality of video files, the processor 701 determines that the plurality of video files should be integrated as one. The processor 701 sets a flag for granting the user device 100 to have access to the stored video file, to the file.

In step 807, the processor 701 (e.g., the provision module 740) provides the video file stored in the memory 703 to the user device 100 in response to a provision request of the user device 100.

As described above, if the amount of video data obtained from an image sensor reaches a video data transmission capacity (e.g., an available capacity of a memory or less), the video data can be stored in an external storage. Therefore, a user can take a large video regardless the available capacity of the memory (e.g., buffer memory) of a user device.

According to various embodiments of the present invention, respective modules can be configured by software, firmware, hardware or a combination thereof Also, some or all of the modules are constructed in one entity, and can identically perform a function of each module. Respective operations can be executed sequentially, repeatedly, or in parallel. Also, some of the operations can be omitted or other operations can be added and executed. For one example, the respective operations can be executed by corresponding modules described above.

Methods disclosed in claims and/or specification of the present invention can be implemented in a form of hardware, software, or a combination of the hardware and the software.

In a case of implementing the methods in the software form, a computer readable storage medium storing one or more programs (i.e., software modules) can be provided. One or more programs stored in the computer readable storage medium are executable by one or more processors within an electronic device. The one or more programs can include instructions for enabling the electronic device to execute the methods disclosed in the claims and/or specification of the present invention.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or an optical storage device of other form, and a magnetic cassette. Alternatively, the programs can be stored in a memory configured by a combination of some or all of them. Also, each configured memory may be included in a plural number.

The programs can be stored in an attachable storage device accessible to the electronic device through a communication network such as the Internet, an intranet, a Local Area Network (LAN), a Wireless LAN (WLAN) and a Storage Area Network (SAN) or a communication network configured by a combination of them. This storage device can access the electronic device through an external port.

A separate storage device on a communication network may access a portable electronic device.

While the present invention has been shown and described with reference to certain embodiments thereof, it will be understood by those skilled in the art that various changes in form and details may be made therein without departing from the spirit and scope of the invention as defined by the appended claims.

What is claimed is:

1. A method in an electronic device, the method comprising:
connecting communication with an external storage;
obtaining video data through an image sensor; and
if an amount of the video data reaches a transmission capacity, transmitting the video data to the external storage.

2. The method of claim 1, further comprising adjusting the transmission capacity.

3. The method of claim 2, wherein adjusting the transmission capacity comprises:
confirming an available capacity of a memory; and
adjusting the transmission capacity to no more than the available capacity of the memory.

4. The method of claim 3, wherein adjusting the transmission capacity to no more than the available capacity of the memory comprises adjusting the transmission capacity in response to a network type and/or network state with the external storage.

5. The method of claim 3, wherein the memory is a buffer memory.

6. The method of claim 1, wherein, if the amount of the video data reaches the transmission capacity, transmitting the video data to the external storage comprises:
converting the video data into a file; and
transmitting the file to the external storage.

7. An electronic device comprising:
a communication module configured to connect communication with an external storage;
an acquisition module configured to obtain video data through an image sensor; and
a transmission module configured to, if an amount of the video data reaches a transmission capacity, transmit the video data to the external storage.

8. The electronic device of claim 7, further comprising an adjustment module configured to adjust the transmission capacity.

9. The electronic device of claim 8, wherein the adjustment module confirms an available capacity of a memory, and adjusts the transmission capacity to no more than the available capacity of the memory.

10. The electronic device of claim 9, wherein the adjustment module confirms a network type and/or network state with the external storage, and adjusts the transmission capacity in response to the network type and/or network state.

11. The electronic device of claim 9, wherein the memory is a buffer memory.

12. The electronic device of claim 7, wherein the transmission module is configured to convert the video data into a file, and transmit the file to the external storage.

13. A method in a storage device, the method comprising:
connecting communication with a user device;
sequentially obtaining a plurality of video files from the user device;
creating the plurality of video files as one file; and
storing the created file.

14. The method of claim 13, wherein creating the plurality of video files as one file and storing the created file comprises setting a flag for granting an access of the user device to the file.

15. The method of claim 13, further comprising providing the file to the user device in response to a provision request from the user device.

16. A storage device comprising:
a communication module configured to connect communication with a user device;
an acquisition module configured to sequentially obtain at least one video file from the user device; and
a creation module configured to create the at least one video file as one file, and storing the created file.

17. The device of claim 16, wherein the creation module sets a flag for granting an access of the user device to the file.

18. The device of claim 16, further comprising a provision module for providing the file to the user device in response to a provision request from the user device.

19. An electronic device comprising:
an image sensor for obtaining video data;
at least one processor configured to execute computer programs;
a memory for storing data and instructions; and
at least one program stored in the memory and configured to be executable by the at least one processor,
wherein the at least one program connects communication with an external storage, obtains video data through the image sensor, and transmits the video data to the external storage if an amount of the video data reaches a transmission capacity, and
wherein the transmission capacity is adjusted to no more than an available capacity of the memory.

20. A storage device comprising:
an image sensor for obtaining video data;
at least one processor configured to execute computer programs;
a memory for storing data and instructions; and
at least one program stored in the memory and configured to be executable by the at least one processor,
wherein the at least one program connects communication with a user device, sequentially obtains a plurality of video files from the user device, creates the plurality of video files as one file, and stores the created file.
